(19) United States
(12) Patent Application Publication
(10) Pub. No.: US 2008/0100735 A1
(43) Pub. Date: May 1, 2008

(54) Image sensor, camera module having the same, and mobile terminal having the same

(75) Inventor: Hae Jin Jeon, Gumi (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/905,313

(22) Filed: Sep. 28, 2007

(30) Foreign Application Priority Data
Oct. 31, 2006 (KR) 10-2006-0106473

(51) Int. Cl. H04N 5/335

(52) U.S. Cl. 348/308

(57) ABSTRACT

Provided is a mobile terminal comprises a camera module including an image sensor having a two-dimensional pixel array in which the number of pixels in a row direction is equal to the number of pixels in a column direction; an image processing unit that converts an electrical signal output from the image sensor into image data; and a display unit that displays the image data output from the image processing unit.

### CROSS-REFERENCE TO RELATED APPLICATIONS

This application claims the benefit of Korean Patent Application No. 10-2006-0106473 filed with the Korea Intellectual Property Office on Oct. 31, 2006, the disclosure of which is incorporated herein by reference.

### BACKGROUND OF THE INVENTION

1. Field of the Invention

The present invention relates to a mobile terminal, and more specifically, to an image sensor of a camera module, which even when an object is photographed in a state where the camera module is rotated, can implement the same image as that of the object which is photographed in a state where the camera module is not rotated, the camera module having the image sensor, and a mobile terminal having the same.

2. Description of the Related Art

With the recent development of the mobile communication technology, various types of personal mobile terminals, such as mobile phones, personal digital assistants (PDAs), smart displays and so on, are launched on the market. In addition to a simple wireless communication function, various functions such as a camera function, a multimedia reproduction function and so on are provided to the mobile terminals.

As display sections of mobile terminals are improved and high-speed communication is realized, the application range of such multimedia functions is gradually widened. Therefore, the mobile terminal can be utilized as a mobile entertainment system.

Among the multimedia functions, the camera function and the multimedia reproduction function are high-class functions which have come into wide use. An object can be photographed by a camera of the mobile terminal, and the quality of a screen is increased enough to watch VOD (Video on Demand). Further, more and more personal mobile terminals include the camera function.

With the technical development of digital cameras, the functions of cameras applied to personal mobile terminals have been also developed. With the technical development of cameras and the rapid development of displays which can display an image obtained through the cameras, personal mobile terminals having a camera function provided therein are generally used.

To implement a camera function in the mobile terminal, a separate camera module should be provided in a body case or folder case of the mobile terminal. In a case of a DMB (Digital Multimedia Broadcasting) phone having a camera module provided on a folder case thereof, an object is usually photographed in a state where the folder case is rotated by 90 degrees.

This is because, while people usually feel a sense of stability when seeing a screen of which the horizontal length is greater than the vertical length, mobile phones such as DMB phones having a camera module provided therein have a case and a screen which are vertically long.

Therefore, as shown in FIG. 1, when an object is photographed in a normal state where a folder case having a camera module provided therein is vertically disposed, a normal image of the object is implemented, because the object is photographed in a state where an image sensor 1 of the camera module is not rotated. However, when the object is photographed in a state where the folder case having the camera module is rotated by 90 degrees, an image rotated by 90 degrees is implemented in comparison with the normal image, because the object is photographed in a state where the image sensor 1 of the camera module is rotated by 90 degrees.

This is because the image sensor 1 provided in the conventional camera module is formed to have a greater horizontal length than a vertical length. For example, the number of horizontal pixels composing a pixel array 1a of the image sensor 1 is 1,600, and the number of vertical pixels is 1,200, which means that the number of horizontal pixels is larger than the number of vertical pixels.

If necessary, a camera module having an image sensor, which is rotated by 90 degrees, may be provided in a folder case. In this case, however, a manufacturing cost increases, because the hardware is changed.

Further, the image rotated by 90 degrees may be changed through software such that an image in which the position of the object is normal can be implemented. However, although the position of the object is changed into a normal position, an image of which the size is different from the image photographed in a state where the camera module is not rotated is inevitably implemented.

### SUMMARY OF THE INVENTION

An advantage of the present invention is that it provides an image sensor of a camera module, which even when an object is photographed in a state where the camera module is rotated, can implement the same image as that of the object which is photographed in a state where the camera module is not rotated, the camera module having the image sensor, and a mobile terminal having the same.

Additional aspects and advantages of the present general inventive concept will be set forth in part in the description which follows and, in part, will be obvious from the description, or may be learned by practice of the general inventive concept.

According to an aspect of the invention, there is provided an image sensor of a camera module, the image sensor having a two-dimensional pixel array in which the number of pixels in a row direction is equal to the number of pixels in a column direction.

According to another aspect of the invention, a camera module comprises at least one or more lenses; and an image sensor that converts light energy incident through the lenses into an electrical signal, the image sensor having a two-dimensional pixel array in which the number of pixels in a row direction is equal to the number of pixels in a column direction.

According to a further aspect of the invention, a mobile terminal comprises a camera module including an image sensor having a two-dimensional pixel array in which the number of pixels in a row direction is equal to the number of pixels in a column direction; an image processing unit that converts an electrical signal output from the image sensor into image data; and a display unit that displays the image data output from the image processing unit.

The mobile terminal further comprises an A/D (Analog/Digital) converter that converts the analog signal output from the image sensor into a digital signal.

Preferably, the image processing unit includes a digital signal processor that converts the electrical signal output from the converter into image data with a predetermined format; a memory that stores the image data converted by the digital signal processor; and a micro computer that controls the overall operation of the image processing unit.

The mobile terminal further comprises a rotation detection sensor that is provided in the camera module so as to detect whether the image sensor is rotated or not.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing an image sensor of a conventional camera module, when the camera module is not rotated, and an image implemented by the image sensor;

FIG. 2 is a diagram showing the image sensor of the conventional camera module, when the camera module is rotated by 90 degrees, and an image implemented by the image sensor;

FIG. 3 is a diagram showing an image sensor of a camera module according to the present invention;

FIG. 4 is a schematic view of a mobile terminal according to the invention;

FIG. 5 is a diagram showing the image sensor, when the camera module according to the invention is not rotated, and an image implemented by the image sensor; and

FIG. 6 is a diagram showing the image sensor, when the camera module according to the invention is rotated by 90 degrees, and an image implemented by the image sensor.

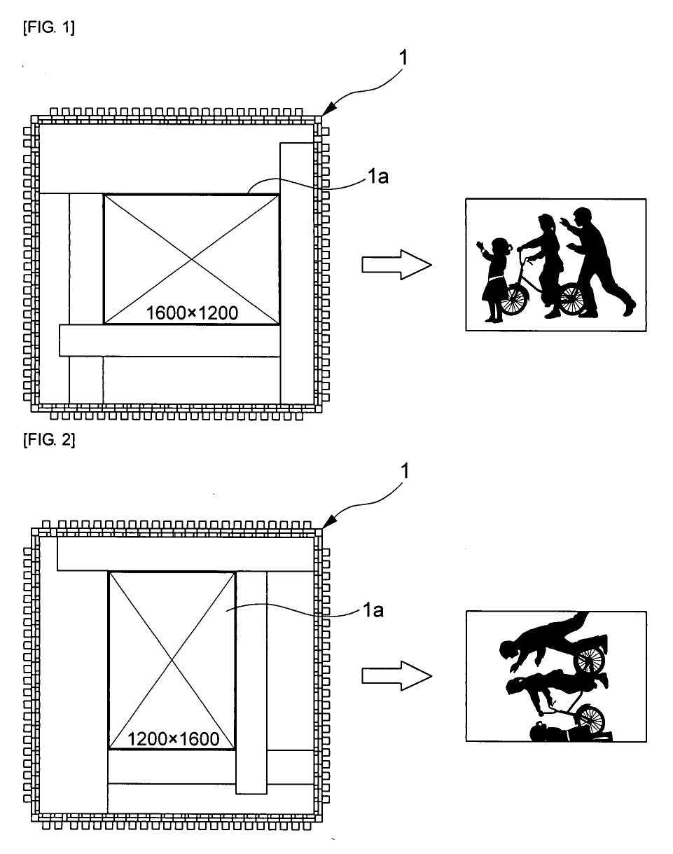

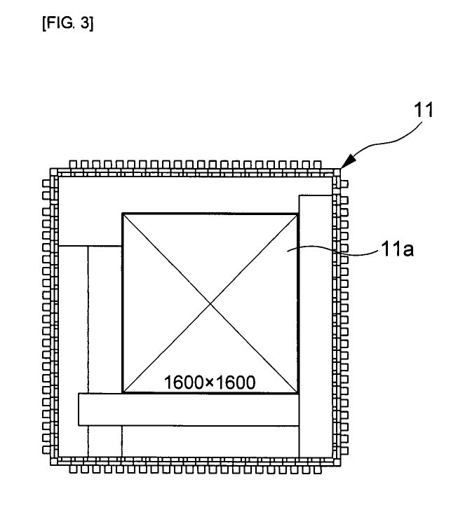

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, embodiments of the present invention will be described in detail with reference to the accompanying drawings.

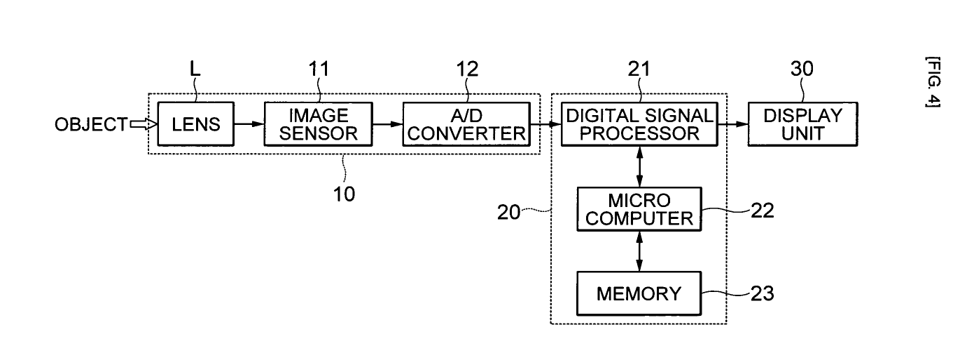

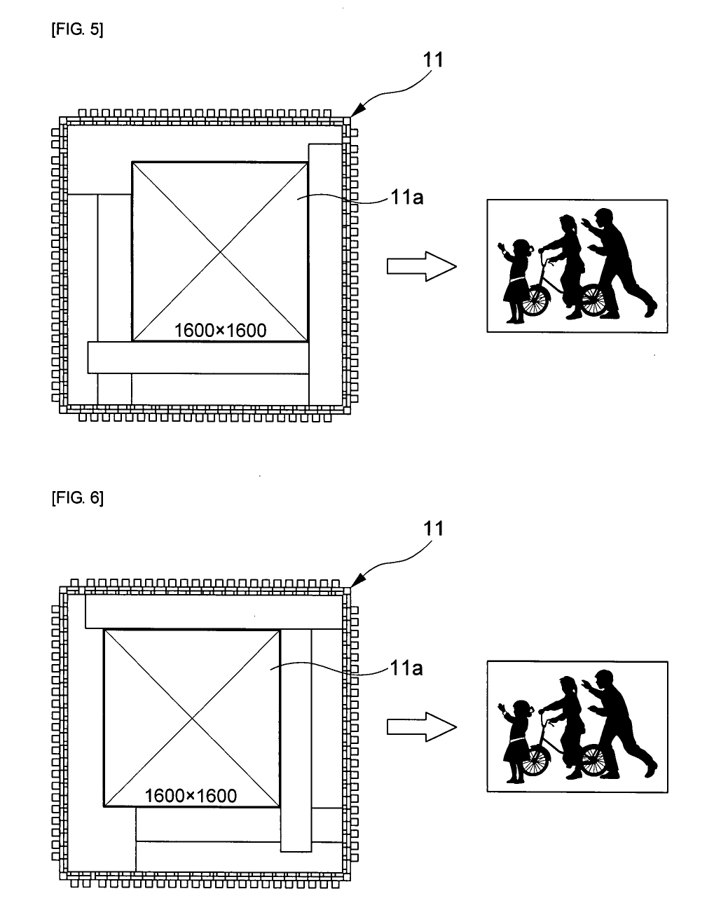

FIG. 3 is a diagram showing an image sensor of a camera module according to the present invention. FIG. 4 is a schematic view of a mobile terminal according to the invention. FIG. 5 is a diagram showing the image sensor, when the camera module according to the invention is not rotated, and an image implemented by the image sensor. FIG. 6 is a diagram showing the image sensor, when the camera module according to the invention is rotated by 90 degrees, and an image implemented by the image sensor.

As shown in FIG. 3, the image sensor 11 of the camera module according to the invention has a two-dimensional pixel array 11a in which the number of pixels in a row direction is equal to the number of pixels in a column direction.

That is, the image sensor 11 has a square pixel array 11a in which the number of horizontal pixels is equal to the number of vertical pixels.

Therefore, when the image sensor 11 is not rotated or is rotated by 90 degrees, the respective numbers of horizontal pixels and vertical pixels, which convert light energy incident on the pixel array 11a into an electrical signal, are equal to each other.

Therefore, the size of an image, implemented by the image sensor 11 when the image sensor 11 is not rotated, is identical to that of an image implemented by the image sensor 11 when the image sensor is rotated by 90 degrees.

Next, as shown in FIG. 4, the camera module 10 according to the invention includes at least one or more lenses L, through which light energy of an object is transmitted, and the image sensor 11 which converts the light energy incident through the lenses L into an electrical signal. The image sensor 11 has the two-dimensional pixel array 11a in which the number of pixels in the row direction is equal to the number of pixels in the column direction.

Therefore, the image sensor module 11 provided in the camera module 10 has the square pixel array 11a in which the number of horizontal pixels is equal to the number of vertical pixels.

Accordingly, the size of an image, implemented by the image sensor 11 when the image sensor 11 is not rotated, is identical to that of an image implemented by the image sensor 11 when the image sensor is rotated by 90 degrees.

Next, as shown in FIG. 4, a mobile terminal according to the invention includes the camera module 10 having the image sensor 11; an A/D (Analog/Digital) converter 12 which converts an analog signal output from the image sensor 11 into a digital signal; an image processing unit 20 which converts an electrical signal output from the image sensor 11 into image data; and a display unit 30 which displays the image data output from the image processing unit 20. The image sensor 11 has the two-dimensional pixel array 11a in which the number of pixels in the row direction is equal to the number of pixels in the column direction.

The image processing unit 20 may include a digital signal processor 21 which converts the electrical signal output from the converter 12 into image data with a predetermined format; a memory 23 which stores the image data converted by the digital signal processor 21; and a micro computer 22 which controls the overall operation of the image processing unit 20.

Now, a process in which an image taken by the camera module of the mobile terminal constructed in such a manner is reproduced will be described.

As shown in FIG. 5, when an object is photographed in a state where the camera module 10 is not rotated, light energy of the object is transmitted through the lens L of the camera module 10 so as to be incident on the pixel array 11a of the image sensor 11, and the incident light energy is converted into an electrical signal through the pixel array 11a. Further, the electrical signal converted through the pixel array 11a is converted into a digital signal by the A/D converter 12. The converted digital signal is converted into image data through the image processing unit 20 so as to be displayed on the display unit 30 such as an LCD. That is, the digital signal converted by the A/D converter 12 is converted into image data with a predetermined format by the digital signal processor 21, and the converted image data is displayed on the display unit 30. At this time, an operation of formatting or storing the image data is controlled by the micro computer 22.

Next, as shown in FIG. 6, when the object is photographed in a state where the camera module 10 is rotated by 90 degrees, light energy of the object is transmitted through the lens L of the camera module 10 so as to be incident on the pixel array 11a of the image sensor 11, and the incident light energy is converted into an electrical signal through the pixel array 11a. Further, the converted analog electrical signal is converted into a digital signal by the A/D converter 12, and the converted digital signal is converted into image data through the image processing unit 20 so as to be displayed on the display unit 30. At this time, when an image photographed in a state where the camera module 10 is not rotated is desired to be obtained in addition to the image which is rotated by 90 degrees, the micro computer 22 controls the digital signal process 21 so as to change the rotated image into an image which is not rotated, through a different line scan method. Then, the image can be displayed on the display unit 30. Further, when an image inverted upside down or inverted right and left is desired to be obtained, the micro computer 22 controls the digital signal processor 21 so as to change the rotated image into an inverted image, through a different line scan method. Then, the image can be displayed on the display unit 30. At this time, the memory 23 of the image processing unit 20 may be composed of a plurality of memories. The image photographed by the camera module 10 is changed in various manners so as to be stored in the respective memories, and the stored image can be displayed on a screen in accordance with a user's request. That is, when an object is photographed in a state where the camera module 10 is not rotated or is rotated, images with the same size can be implemented by a software-like method, because the image sensor 11 according to the invention has the pixel array 11a in which the number of horizontal pixels is equal to the number of vertical pixels.

Although not shown, the camera module may further include a rotation detection sensor which detects whether the image sensor is rotated or not.

That is, when an object is photographed, the rotation detection sensor can immediately grasp whether the camera module is rotated or not. Therefore, it is possible to implement a normal-state image at all times.

In addition, the camera module may further include an image signal processor serving as an image quality improving device which supports an optical zoom function and an auto-focusing function so as to adjust the color tone and brightness of image data like an actual image.

According to the invention, even when an object is photographed in a state where the camera module is rotated, it is possible to implement the same image as that of the object photographed when the camera module is not rotated. Therefore, it is possible to provide an optimal camera solution.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image sensor of a camera module, the image sensor having a two-dimensional pixel array in which the number of pixels in a row direction is equal to the number of pixels in a column direction.

2. A camera module comprising:
at least one or more lenses; and
an image sensor that converts light energy incident through the lenses into an electrical signal, the image sensor having a two-dimensional pixel array in which the number of pixels in a row direction is equal to the number of pixels in a column direction.

3. A mobile terminal comprising:
a camera module including an image sensor having a two-dimensional pixel array in which the number of pixels in a row direction is equal to the number of pixels in a column direction;
an image processing unit that converts an electrical signal output from the image sensor into image data; and
a display unit that displays the image data output from the image processing unit.

4. The mobile terminal according to claim 3 further comprising:
an A/D (Analog/Digital) converter that converts the analog signal output from the image sensor into a digital signal.

5. The mobile terminal according to claim 4, wherein the image processing unit includes:
a digital signal processor that converts the electrical signal output from the converter into image data with a predetermined format;
a memory that stores the image data converted by the digital signal processor; and
a micro computer that controls the overall operation of the image processing unit.

6. The mobile terminal according to claim 3 further comprising:
a rotation detection sensor that is provided in the camera module so as to detect whether the image sensor is rotated or not.
